(19) United States
(12) Patent Application Publication
(10) Pub. No.: US 2025/0372651 A1
(43) Pub. Date: Dec. 4, 2025

(54) SECONDARY BATTERY AND METHOD FOR PRODUCTION OF SECONDARY BATTERY

(71) Applicants: TOYOTA JIDOSHA KABUSHIKI KAISHA, Toyota-shi, Aichi (JP); DAIKIN INDUSTRIES, LTD, Osaka-shi, Osaka (JP)

(72) Inventors: Kazushige NOMOTO, Sunto-gun, Shizuoka-ken (JP); Hideaki NISHIMURA, Sunto-gun, Shizuoka-ken (JP); Fuminori MIZUNO, Miyoshi-shi, Aichi-ken (JP); Kentaro HIRAGA, Osaka-shi, Osaka-fu (JP); Takaya YAMADA, Osaka-shi, Osaka-fu (JP); Akinari SUGIYAMA, Osaka-shi, Osaka-fu (JP)

(73) Assignees: TOYOTA JIDOSHA KABUSHIKI KAISHA, Toyota-shi, Aichi (JP); DAIKIN INDUSTRIES, LTD, Osaka-shi, Osaka (JP)

(21) Appl. No.: 18/874,426

(22) PCT Filed: Jun. 16, 2023
(86) PCT No.: PCT/JP2023/022423

§ 371 Date: Dec. 12, 2024

(30) Foreign Application Priority Data
Jun. 17, 2022 (JP) 2022-098282

(51) Int. Cl. H01M 4/60; H01M 4/02; H01M 4/04; H01M 4/36; H01M 4/38; H01M 10/0562

(52) U.S. Cl. CPC H01M 4/602; H01M 4/0433; H01M 4/364; H01M 4/386; H01M 10/0562; H01M 2004/021; H01M 2004/027

(57) ABSTRACT

Disclosed is a novel technology for reducing the resistance and improving the cycle characteristics of a secondary battery including a sulfide solid electrolyte. The secondary battery of the present disclosure includes a first electrode, an electrolyte layer, and a second electrode, wherein at least one of the first electrode and the electrolyte layer contains a sulfide solid electrolyte, and the first electrode contains an active material having voids and a perfluoropolyether represented by formula (1) below. E₁-Rf₁-R^{F}-O—Rf₂-E₂ (1)

### FIELD

The present invention relates to a secondary battery and a method for the production of a secondary battery.

### BACKGROUND

Patent Literature 1 discloses the use of specific porous silicon particles as a negative electrode active material in order to suppress increases in restraining pressure of a battery during charging. Patent Literature 2 discloses silicon clathrate particles having voids as an active material which exhibits small volumetric changes during charging and discharging. Patent Literature 3 discloses a perfluoropolyether as an additive component of a non-aqueous electrolytic solution. Patent Literature 4 discloses that a perfluoropolyether group-containing compound is present on the surface of an electrode to improve the storage stability of the electrode.

### CITATION LIST

### Patent Literature

[PTL 1] Japanese Unexamined Patent Publication No. 2020-170605

[PTL 2] Japanese Unexamined Patent Publication No. 2020-087886

[PTL 3] Japanese Unexamined Patent Publication No. 2018-200866

[PTL 4] Japanese Unexamined Patent Publication No. 2018-147887

### SUMMARY

### Technical Problem

It is believed that when producing a secondary battery, the resistance of the electrodes and the like can be reduced by pressing the electrodes and the like at high pressure. In particular, it is believed that when producing a secondary battery containing a sulfide solid electrolyte, the effect of reducing resistance by high pressure pressing is remarkable. However, when an electrode or the like is pressed at high pressure, the active material contained in the electrode is likely to deform. For example, when an active material having voids as disclosed in Patent Literature 1 and 2 is pressed at high pressure, the active material is likely to be crushed, whereby the voids are likely to be eliminated. When the voids in the active material are eliminated, volumetric changes of the active material accompanying charging and discharging become large, whereby the cycle characteristics of the secondary battery are likely to deteriorate. During production of a secondary battery comprising a sulfide solid electrolyte, when an electrode or the like is pressed at low pressure to avoid crushing of the active material, it is difficult to obtain the resistance reduction effect described above. Thus, there is room for improvement in secondary batteries comprising a sulfide solid electrolyte in terms of achieving both improved cycle characteristics and reduced resistance.

### Solution To Problem

As means for solving the problem described above, the present disclosure provides the following plurality of aspects.

### <Aspect 1>

A secondary battery, comprising a first electrode, an electrolyte layer, and a second electrode, wherein
at least one of the first electrode and the electrolyte layer contains a sulfide solid electrolyte, and
the first electrode contains an active material having voids and a perfluoropolyether represented by formula (1) below:

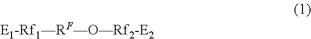

where Rf₁ and Rf₂ are each independently a C₁₋₁₆ divalent alkylene group which may be substituted with one or more fluorine atoms,
E₁ and E₂ are each independently a monovalent group selected from the group consisting of a fluorine group, a hydrogen group, a hydroxyl group, an aldehyde group, a carboxylic acid group, a C₁₋₁₀ alkyl ester group, an amide group which may have one or more substituents, and an amino group which may have one or more substituents, and
R^{F} is a divalent fluoropolyether group.

### <Aspect 2>

The secondary battery according to Aspect 1, wherein
R^{F} is a group represented by formula (2):

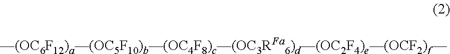

where each R^{Fa} is independently a hydrogen atom, a fluorine atom, or a chlorine atom,
a, b, c, d, e, and f are each independently an integer of 0 to 200,
the sum of a, b, c, d, e, and f is 1 or more,
the order of occurrence of each repeating unit enclosed in parentheses with the subscript a, b, c, d, e, or f is arbitrary in the formula, and
under the proviso that when all R^{Fa} are hydrogen atoms or chlorine atoms, at least one of a, b, c, e, and f is 1 or more.

### <Aspect 3>

The secondary battery according to Aspect 2, wherein each R^{Fa} is a fluorine atom.

### <Aspect 4>

The secondary battery according to Aspect 3, wherein each R^{F} is independently a group represented by formula (2-1), (2-2), (2-3), (2-4), or (2-5) below:

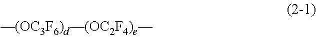

where d is an integer from 1 to 200, and e is 0 or 1;

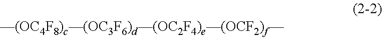

where c and d are each independently an integer of 0 to 30,
e and f are each independently an integer of 1 to 200,
the sum of c, d, e, and f is an integer of 10 to 200, and
the order of occurrence of each repeating unit enclosed in parentheses with the subscript c, d, e or f is arbitrary in the formula;

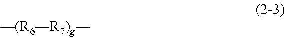

where R₆ is OCF₂ or OC₂F₄,
R₇ is a group selected from OC₂F₄, OC₃F₆, OC₄F₈, OC₅F₁₀, and OC₆F₁₂, or a combination of two or three groups selected from these groups, and
g is an integer of 2 to 100;

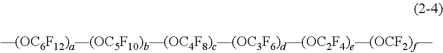

where e is an integer of 1 or more and 200 or less,
a, b, c, d, and f are each independently an integer of 0 or more and 200 or less, and
the order of occurrence of each repeating unit enclosed in parentheses with the subscript a, b, c, d, e, or f is arbitrary in the formula; and

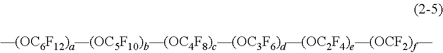

where f is an integer of 1 or more and 200 or less,
a, b, c, d, and e are each independently an integer of 0 or more and 200 or less, and
the order of occurrence of each repeating unit enclosed in parentheses with the subscript a, b, c, d, e, or f is arbitrary in the formula.

### <Aspect 5>

The secondary battery according to Aspect 4, wherein each R^{F} is a group represented by formula (2-6) below:

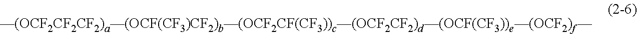

where a, b, c, d, e, and f are each independently an integer of 0 to 200,
the sum of a, b, c, d, e, and f is 1 or more, and
the order of occurrence of each repeating unit enclosed in parentheses with the subscript a, b, c, d, e, or f is arbitrary in the formula.

### <Aspect 6>

The secondary battery according to Aspect 4, wherein each Rr is a group represented by formula (2-7) below:

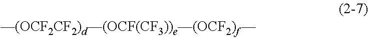

where d, e, and f are each independently an integer of 0 to 200,
the sum of d, e, and f is 1 or more, and
the order of occurrence of each repeating unit enclosed in parentheses with the subscript d, e, or f is arbitrary in the formula.

### <Aspect 7>

The secondary battery according to any one of Aspects 1 to 6, wherein E₁-Rf₁ and E₂-Rf₂ are each independently a group selected from the group consisting of —CF₃, —CF₂CF₃, and —CF₂CF₂CF₃.

### <Aspect 8>

The secondary battery according to any one of Aspects 1 to 7, wherein the first electrode comprises a first active material layer, and
the first active material layer contains 1 vol % or more and 25 vol % or less of the perfluoropolyether.

### <Aspect 9>

The secondary battery according to any one of Aspects 1 to 8, wherein the first electrode is a negative electrode, and
the active material having the voids contains Si or a Si alloy.

### <Aspect 10>

The secondary battery according to any one of Aspects 1 to 9, wherein the first electrode contains the sulfide solid electrolyte, the active material having the voids, and the perfluoropolyether.

### <Aspect 11>

A method for the production of a secondary battery, comprising the steps of:
molding a first electrode mixture to obtain a first electrode,
molding an electrolyte mixture to obtain an electrolyte layer, and
molding a second electrode mixture to obtain a second electrode, wherein
at least one of the first electrode mixture and the electrolyte mixture contains a sulfide solid electrolyte,
the first electrode mixture contains an active material having voids and a perfluoropolyether represented by formula (1) below, and
during molding of the first electrode mixture, a pressure exceeding 0 kN/cm and 15 kN/cm or less is exerted on the first electrode mixture:

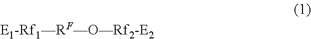

where Rf₁ and Rf₂ are each independently a C₁₋₁₆ divalent alkylene group which may be substituted with one or more fluorine atoms,
E₁ and E₂ are each independently a monovalent group selected from the group consisting of a fluorine group, a hydrogen group, a hydroxyl group, an aldehyde group, a carboxylic acid group, a C₁₋₁₀ alkyl ester group, an amide group which may have one or more substituents, and an amino group which may have one or more substituents, and
R^{F} is a divalent fluoropolyether group.

### EFFECTS OF INVENTION

In the secondary battery of the present disclosure, it is easy to achieve both excellent cycle characteristics and low resistance.

### BRIEF DESCRIPTION OF DRAWINGS

FIG. 1 schematically shows an example of a secondary battery configuration.

### DESCRIPTION OF EMBODIMENTS

### 1. Secondary Battery

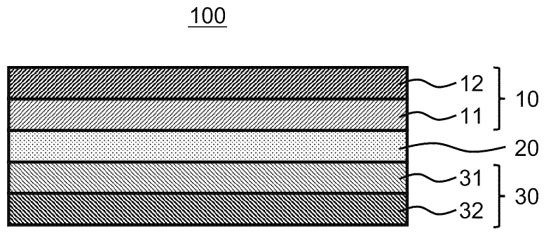

Embodiments of the technology of the present disclosure will be described below, but the technology of the present disclosure is not limited to the following embodiments. As shown in FIG. 1, a secondary battery 100 according to an embodiment comprises a first electrode 10, an electrolyte layer 20, and a second electrode 30. At least one of the first electrode 10 and the electrolyte layer 20 contains a sulfide solid electrolyte. Furthermore, the first electrode 10 contains an active material having voids and a perfluoropolyether represented by the following formula (1).

### 1.1 First Electrode

The first electrode 10 may be a negative electrode or a positive electrode. When the first electrode 10 is a negative electrode, the second electrode 30 is a positive electrode. The first electrode 10 may have various configurations as long as it contains an active material having voids and a specific perfluoropolyether and can function appropriately as a negative electrode or a positive electrode of a secondary battery.

### 1.1.1 Active Material Having Voids

During charging and discharging of a secondary battery, carrier ions are absorbed or released from the active material, causing changes in the volume of the active material. Excessive expansion of the active material during charging or discharging may adversely affect the cycle characteristics of the battery. In order to alleviate the expansion of the active material, it is considered effective that voids be formed in the active material. Specifically, in an active material having voids, expansion during charging or discharging is absorbed by the voids, whereby changes in volume are likely to be small.

There are various active materials having voids. For example, the active material may have voids due to being porous, or may have voids due to being hollow. Specifically, the voids in the active material may be present only inside the active material, may reach the surface from the inside of the active material, or may be a mixture of those present only inside the active material and those reaching the surface from the inside. The active material may have voids in the primary particles themselves (for example, those having voids inside the primary particles), or may have voids between aggregated primary particles in a state in which a plurality of primary particles are aggregated to form secondary particles. The voids have a size large enough to absorb the expansion of the volume of the active material. At least a portion of the voids may or may not be filled with a perfluoropolyether, which will be described later. The voids may not be minute gaps used for the intercalation of carrier ions. Whether or not the active material has voids can be determined, for example, by observing the cross section of the active material with a scanning electron microscope (SEM) or the like.

The porosity of the active material is not particularly limited. For example, the porosity of the active material may be 1% or more, 2% or more, 3% or more, or 4% or more, and may be 60% or less, 50% or less, 40% or less, 30% or less, or 20% or less. The porosity of the active material can be specified, for example, as follows. First, a cross section of the first electrode 10 containing the active material is exposed by ion milling. The cross section is then observed with an SEM to obtain a photograph of the particles. From the obtained photograph, the active material portion and the void portions in the active material are clearly distinguished using image analysis software and binarized. The areas of the active material portion and the void portions are obtained, and the porosity (%) is calculated from the formula below. Furthermore, the specific conditions for calculating the porosity may be, for example, the conditions specifically described in Patent Literature 2 (Japanese Unexamined Patent Publication (Kokai) No. 2020-087886).

$$Porosity ( \% ) = 100 \times ( void portion area ) / ( ( active material portion area ) + ( void portion area ) )$$

The active material having voids may be either a negative electrode active material or a positive electrode active material. In particular, when the first electrode 10 is a negative electrode and the active material having voids is a negative electrode active material, and in particular, when the active material having voids contains Si or a Si alloy, the effect of the technology of the present disclosure is more likely to be enhanced. The volume of a Si-based active material containing Si or a Si alloy is likely to expand during charging, and the active material having voids can alleviate the volume expansion. Specific examples of Si-based active materials containing Si or a Si alloy include those having a clathrate structure. Whether or not a Si-based active material has a clathrate structure can be easily determined from Raman spectroscopy, XRD, or the like. For example, when the ratio I₃₂₅/I₂₀₅ of the maximum peak intensity I₃₂₅ at 325+10 cm⁻¹ and the maximum peak intensity I₂₀₅ at 205+10 cm⁻¹ measured by Raman spectroscopy is within the range of 1.03 to 1.21, it may be determined that the Si-based active material has a clathrate structure. Alternatively, the first electrode 10 may be a positive electrode, and the active material having voids may be a positive electrode active material such as a sulfur-based active material (such as elemental sulfur or Li₂S). Though such a positive electrode active material is prone to volume expansion during discharge, by including an active material have voids, the volume expansion can be alleviated. Furthermore, an oxide film or the like may be formed on the active material, and impurities such as carbon may be included.

The active material having voids may be, for example, particulate. The size of the active material having voids is not particularly limited. The average particle size of the active material having voids may be, for example, 1 nm or more, 5 nm or more, 10 nm or more, 50 nm or more, 100 nm or more, 300 nm or more, or 500 nm or more, and may be 50 μm or less, 30 μm or less, 10 μm or less, or 5 μm or less. The average particle size of the active material is the particle size (median size) at 50% cumulative value in the volume-based particle size distribution obtained by the laser diffraction/scattering method.

### 1.1.2 Perfluoropolyether (PFPE)

In order to reduce the resistance of the secondary battery, high-pressure pressing may be applied to the electrode or the like during the production of the secondary battery. In this case, the active material having voids described above is crushed, whereby the voids are likely to be eliminated, and the effect of mitigating the expansion of the active material is unlikely to be obtained. In order to avoid such crushing of the active material, it is effective to press the electrode or the like at a low pressure during the production of the secondary battery, but in this case, the resistance of the secondary battery is likely to be high. In contrast, in the secondary battery 100 of the present disclosure, since the first electrode 10 contains a predetermined perfluoropolyether (PFPE), even if low-pressure pressing is adopted during the production of the secondary battery, the resistance of the first electrode 10 and the secondary battery 100 is likely to be reduced due to the lubricating effect of the PFPE.

Furthermore, according to the new findings of the present inventors, PFPE has a high affinity for the surfaces of various battery materials because of the ether bond thereof, and it is believed that PFPE can be appropriately present in, for example, the voids between the active materials or the voids between the sulfide solid electrolyte materials. This further enhances the lubricating effect in the first electrode 10, and even when the first electrode 10 is pressed at a low pressure, it becomes easier to further increase the density of the material of the first electrode 10, whereby it becomes easier to further reduce the resistance of the first electrode 10.

The perfluoropolyether is represented by the following formula (1).

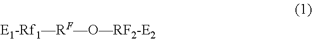

where Rf₁ and Rf₂ are each independently a C₁₋₁₆ divalent alkylene group which may be substituted with one or more fluorine atoms,
E₁ and E₂ are each independently a monovalent group selected from the group consisting of a fluorine group, a hydrogen group, a hydroxyl group, an aldehyde group, a carboxylic acid group, a C₁₋₁₀ alkyl ester group, an amide group which may have one or more substituents, and an amino group which may have one or more substituents, and
R^{F} is a divalent fluoropolyether group.

In the above formula (1), Rf₁ and Rf₂ each independently represent a C₁₋₁₆ divalent alkylene group optionally substituted with one or more fluorine atoms.

In one aspect, the “C₁₋₁₆ divalent alkylene group” in the above-mentioned C₁₋₁₆ divalent alkylene group optionally substituted by one or more fluorine atoms may be a straight chain or a branched chain, preferably a straight chain or branched chain C₁₋₆ alkylene group, particularly a C₁₋₃ alkylene group, more preferably a straight chain C₁₋₆ alkylene group, and particularly a C₁₋₃ alkylene group.

In an aspect, the “C₁₋₁₆ divalent alkylene” in the above-mentioned C₁₋₁₆ divalent alkylene group optionally substituted by one or more fluorine atoms may be linear or branched, and is preferably a linear or branched C₁₋₆ fluoroalkylene group, in particular a C₁₋₃ fluoroalkylene group, specifically, —CF₂CH₂— and —CF₂CF₂CH₂—, and more preferably a linear C₁₋₆ perfluoroalkylene group, in particular a C₁₋₃ perfluoroalkylene group, and specifically, a group selected from the group consisting of —CF₂—, —CF₂CF₂— and —CF₂CF₂CF₂—.

In the above formula (1), E₁ and E₂ are each independently a monovalent group selected from the group consisting of a fluorine group, a hydrogen group, a hydroxyl group, an aldehyde group, a carboxylic acid group, a C₁₋₁₀ alkyl ester group, an amide group which may have one or more substituents, and an amino group which may have one or more substituents.

The PFPE has low reactivity with the sulfide solid electrolyte. Thus, even when the PFPE comes into contact with the sulfide solid electrolyte, ion conductivity is unlikely to decrease due to change or deterioration of the sulfide solid electrolyte. In particular, when the first electrode contains a PFPE having a non-polar group as an end group, the reaction between the PFPE and the sulfide solid electrolyte is further suppressed, and even greater effects can be expected. In this regard, the E₁ and E₂ are each independently preferably a fluorine group. In an aspect, E₁-Rf₁ and E₂-Rf₂ may each independently be a group selected from the group consisting of —CF₃, —CF₂CF₃, and —CF₂CF₂CF₃.

In formula (1) described above, each R^{F} is independently a divalent fluoropolyether group.
each R′ is preferably a group represented by formula (2):

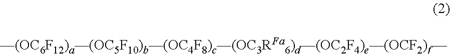

where each R^{Fa} is independently a hydrogen atom, a fluorine atom, or a chlorine atom,
a, b, c, d, e, and f are each independently an integer of 0 to 200,
the sum of a, b, c, d, e, and f is 1 or more,
the order of occurrence of each repeating unit enclosed in parentheses with the subscript a, b, c, d, e, or f is arbitrary in the formula, and
under the proviso that when all R^{Fa} are hydrogen atoms or chlorine atoms, at least one of a, b, c, e, and f is 1 or more.
R^{Fa} is preferably a hydrogen atom or a fluorine atom, and more preferably a fluorine atom.
a, b, c, d, e and f may preferably each independently be an integer from 0 to 100.

The sum of a, b, c, d, e, and f is preferably 5 or more, more preferably 10 or more, and may be, for example, 15 or more or 20 or more. The sum of a, b, c, d, e, and f is preferably 200 or less, more preferably 100 or less, and further preferably 60 or less, and may be, for example, 50 or less or 30 or less.

These repeating units may be linear or branched. For example:
—(OC₆F₁₂)— may be any of —(OCF₂CF₂CF₂CF₂CF₂CF₂)—, —(OCF(CF₃)CF₂CF₂CF₂CF₂)—, —(OCF₂CF(CF₃)CF₂CF₂CF₂)—, —(OCF₂CF₂CF(CF₃)CF₂CF₂)—, —(OCF₂CF₂CF₂CF(CF₃)CF₂)—, and —(OCF₂CF₂CF₂CF₂CF(CF₃))—.
—(OC₅F₁₀)— may be any of —(OCF₂CF₂CF₂CF₂CF₂CF₂)—, —(OCF(CF₃)CF₂CF₂CF₂CF₂)—, —(OCF₂CF(CF₃)CF₂CF₂)—, —(OCF₂CF₂CF(CF₃)CF₂)—, and —(OCF₂CF₂CF₂CF(CF₃))—.
—(OC₄F₈)— may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C₂F₅)CF₂)—, and —(OCF₂CF(C₂F₅))—.
—(OC₃F₆)— (i.e., the case in which R^{Fa} is a fluorine atom in formula (2) above) may be any of —(OCF₂CF₂CF₂)—, —(OCF(CF₃)CF₂)—, and —(OCF₂CF(CF₃))—.
—(OC₂F₄)— may be either —(OCF₂CF₂)— or —(OCF(CF₃))—.

In an aspect, each R^{F} may independently be a group represented by any one of the following formulas (2-1) to (2-5).

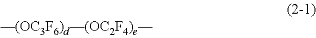

where d is an integer from 1 to 200, and e is 0 or 1.

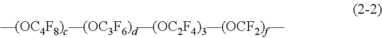

where c and d are each independently an integer of 0 to 30,
e and f are each independently an integer of 1 or more and 200 or less,
the sum of c, d, e, and f is 2 or more, and
the order of occurrence of each repeating unit enclosed in parentheses with the subscript c, d, e or f is arbitrary in the formula.

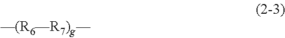

where R₆ is OCF₂ or OC₂F₄,
R₇ is a group selected from OC₂F₄, OC₃F₆, OC₄F₈, OC₅F₁₀, and OC₆F₁₂, or a combination of two or three groups selected from these groups, and
g is an integer of 2 to 100.

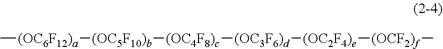

where e is an integer of 1 or more and 200 or less,
a, b, c, d, and f are each independently an integer of 0 or more and 200 or less, and
the order of occurrence of each repeating unit enclosed in parentheses with the subscript a, b, c, d, e, or f is arbitrary in the formula.

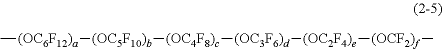

where f is an integer of 1 or more and 200 or less,
a, b, c, d, and e are each independently an integer of 0 or more and 200 or less, and
the order of occurrence of each repeating unit enclosed in parentheses with the subscript a, b, c, d, e, or f is arbitrary in the formula.

In formula (2-1) above, d is preferably an integer of 5 to 200, more preferably 10 to 100, further preferably 15 to 50, and is, for example, an integer of 25 to 35. Formula (2-1) above is preferably a group represented by —(OCF₂CF₂CF₂)_{d}— or —(OCF(CF₃)CF₂)_{d}—, and more preferably a group represented by —(OCF₂CF₂CF₂)_{d}—. In an aspect, e is 0. In another aspect, e is 1.

In formula (2-2) above, e and f are each independently an integer of preferably 5 to 200, and more preferably 10 to 200. The sum of c, d, e, and f is preferably 5 or more, more preferably 10 or more, and may be, for example, 15 or more or 20 or more. In an aspect, formula (2-2) above is preferably a group represented by —(OCF₂CF₂CF₂CF₂)_{c}—(OCF₂CF₂CF₂)_{d}—(OCF₂CF₂)ₑ—(OCF₂)_{f}—. In another aspect, formula (2-2) may be a group represented by —(OC₂F₄)ₑ—(OCF₂)_{f}—.

In formula (2-3) above, R⁶ is preferably OC₂F₄. In formula (2-3) above, R⁷ is preferably a group selected from OC₂F₄, OC₃F₆, and OC₄F₈, or a combination of two or three groups independently selected from these groups, and is more preferably a group selected from OC₃F₆ and OC₄F₈. The combination of two or three groups independently selected from OC₂F₄, OC₃F₆ and OC4F8 is not particularly limited, and examples thereof include —OC₂F₄₀C₃F₆—, —OC₂F₄₀C₄F₈—, —OC₃F₆OC₂F₄—, —OC₃F₆OC₃F₆—, —OC₃F₆OC₄F₈—, —OC₄F₈OC₄F₈—, —OC₄F₈OC₃F₆—, —OC₄F₈OC₂F₄—, —OC₂F₄OC₂F₄₀C₃F₆—, —OC₂F₄₀C₂F₄OC₄F₈—, —OC₂F₄₀C₃F₆OC₂F₄—, —OC₂F₄₀C₃F₆OC₃F₆—, —OC₂F₄OC₄F₈OC₂F₄—, —OC₃F₆OC₂F₄OC₂F₄—, —OC₃F₆OC₂F₄₀C₃F₆—, —OC₃F₆OC₃F₆OC₂F₄—, and —OC₄F₈OC₂F₄₀C₂F₄—. In formula (2-3) above, g is preferably an integer of 3 or more, and more preferably 5 or more. g is preferably an integer of 50 or less. In formula (2-3) above, OC₂F₄, OC₃F₆, OC₄F₈, OC₅F₁₀, and OC₆F₁₂ may be either linear or branched, and are preferably linear. In this aspect, formula (2-3) above is preferably —(OC₂F₄—OC₃F₆)_{g}— or —(OC₂F₄—OC₄F₈)_{g}—.

In formula (2-4) above, e is preferably an integer of 1 or more and 100 or less, and more preferably an integer of 5 or more and 100 or less. The sum of a, b, c, d, e, and f is preferably 5 or more, more preferably 10 or more, for example, 10 or more and 100 or less.

In formula (2-5) above, f is preferably an integer of 1 or more and 100 or less, and more preferably an integer of 5 or more and 100 or less. The sum of a, b, c, d, e, and f is preferably 5 or more, more preferably 10 or more, for example, 10 or more and 100 or less.

In an aspect, each R^{F} is a group represented by formula (2-1).

In an aspect, each R^{F} is a group represented by formula (2-2).

In an aspect, each R^{F} is a group represented by formula (2-3).

In an aspect, each R^{F} is a group represented by formula (2-4).

In an aspect, each R^{F} is a group represented by formula (2-5).

In R^{F}, the ratio of e to f (hereinafter referred to as the “e/f ratio”) may be 0.5 to 4, preferably 0.6 to 3, more preferably 0.7 to 2, and further preferably 0.8 to 1.4. By setting the e/f ratio to 4 or less, lubricity and chemical stability are further improved. The smaller the e/f ratio, the greater lubricity is improved. Conversely, by setting the e/f ratio to 0.5 or more, the stability of the compound can be further improved. The greater the e/f ratio, the more the stability of the fluoropolyether structure is improved. In this case, the value of f is preferably 0.8 or more.

In an aspect, each R^{F} may be a group represented by the following formula (2-6):

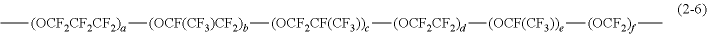

where a, b, c, d, e, and f are each independently an integer of 0 to 200,
the sum of a, b, c, d, e, and f is 1 or more, and
the order of occurrence of each repeating unit enclosed in parentheses with the subscript a, b, c, d, e, or f is arbitrary in the formula.

In an embodiment, each R^{F} may be a group represented by the following formula (2-7):

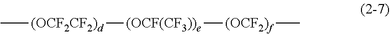

where d, e, and f are each independently an integer of 0 to 200,
the sum of d, e, and f is 1 or more, and
the order of occurrence of each repeating unit enclosed in parentheses with the subscript d, e, or f is arbitrary in the formula.

In R^{F}, the ratio of d to f (hereinafter referred to as “d/f ratio”) may be 0.5 to 4, preferably 0.6 to 3, more preferably 0.7 to 2, and further preferably 0.8 to 1.4. By setting the d/f ratio to 4 or less, lubricity and chemical stability are further improved. The smaller the d/f ratio, the greater lubricity is improved. Conversely, by setting the d/f ratio to 0.5 or more, the stability of the compound can be further improved. The greater the d/f ratio, the more the stability of the fluoropolyether structure is improved. In this case, the value of f is preferably 0.8 or more.

In the fluoropolyether group-containing compound described above, the number average molecular weight of each R^{F} portion is not particularly limited, and is, for example, 500 to 30,000, preferably 1,500 to 30,000, and more preferably 2,000 to 10,000. In the present description, the number average molecular weight of R^{F} is a value measured by ¹⁹F—NMR.

The content of the PFPE in the first electrode 10 is not particularly limited and can be appropriately selected in accordance with the desired performance. In particular, in the case in which the first electrode 10 comprises a first active material layer 11, which will be described later, when the first active material layer 11 contains the PFPE described above in an amount of 1 vol % or more and 25 vol % or less, a greater effect is likely to be obtained. The first active material layer 11 may contain the PFPE described above in an amount of, for example, 1 vol % or more, 3 vol % or more, 5 vol % or more, 7 vol % or more, 8 vol % or more, 9 vol % or more, 10 vol % or more, 11 vol % or more, or 12 vol % or more, and 25 vol % or less, 24 vol % or less, 22 vol % or less, 20 vol % or less, 18 vol % or less, 16 vol % or less, 14 vol % or less, or 12 vol % or less.

The volume ratio of the PFPE in the first active material layer 11 is measured as follows. Specifically, the volume of the first active material layer 11 is measured in advance using an optical microscope or SEM. The content volume of the PFPE may be identified by washing the first active material layer 11 with a solvent (a solvent capable of dissolving the PFPE without dissolving other electrode materials), recovering the filtrate in which the PFPE is dissolved by suction filtration or the like, and analyzing the recovered solvent by GC-MS. In the case where the solvent has a boiling point significantly different from that of the PFPE, the PFPE may be extracted by distillation, and the volume of the PFPE may be directly measured. In this manner, the volume ratio of the PFPE to the volume of the first active material layer 11 measured in advance is calculated.

### 1.1.3 First Active Material Layer

As shown in FIG. 1, the first electrode 10 may comprise a first active material layer 11 and a first current collector 12. In this case, the first active material layer 11 may contain the active material having voids described above and a predetermined PFPE. The first active material layer 11 may be a positive electrode active material layer or a negative electrode active material layer. When the first active material layer 11 is a negative electrode active material layer, the second active material layer 31 is a positive electrode active material layer.

The negative electrode active material layer contains at least a negative electrode active material, and may further contain an electrolyte, a conductive aid, a binder, etc. The negative electrode active material layer may also contain various other additives. For example, it may contain the PFPE described above. The content of each component in the negative electrode active material layer may be appropriately determined in accordance with the desired battery performance. For example, when the total solid content of the negative electrode active material layer is 100 mass %, the content of the negative electrode active material may be 40 mass % or more, 50 mass % or more, 60 mass % or more, or 70 mass % or more, and may be 100 mass % or less, 95 mass % or less, or 90 mass % or less. Alternatively, when the total negative electrode active material layer is 100 vol %, the negative electrode active material, and optionally the electrolyte, the conductive aid, the binder, and the PFPE may be a total of 85 vol % or more, 90 vol % or more, or 95 vol % or more, with the remainder being voids or other components. The shape of the negative electrode active material layer is not particularly limited, and may be, for example, a sheet-like negative electrode active material layer having a substantially flat surface. The thickness of the negative electrode active material layer is not particularly limited, and may be, for example, 0.1 μm or more, 1 μm or more, or 10 μm or more, and may be 2 mm or less, 1 mm or less, or 500 μm or less.

As the negative electrode active material, various substances which have a potential (charge/discharge potential) for absorbing and releasing predetermined carrier ions (for example, lithium ions) that is lower than that of the positive electrode active material can be adopted. For example, the negative electrode active material may be at least one selected from Si-based active materials such as Si, Si alloys, and silicon oxide; carbon-based active materials such as graphite and hard carbon; various oxide-based active materials such as lithium titanate; metallic lithium, lithium alloys, and the like. In particular, as described above, when the negative electrode active material is a Si-based active material containing Si or a Si alloy, the technology of the present disclosure is likely to provide even greater effects. One type of negative electrode active material may be used alone, or two or more types thereof may be used in combination.

The shape of the negative electrode active material may be a shape which is generally used in the negative electrode active material for a battery. As described above, the negative electrode active material may be, for example, particulate. As described above, the negative electrode active material may have voids, for example, may be porous or hollow. When an active material having voids is included as the positive electrode active material, which will be described later, the negative electrode active material may or may not have voids, and may be a combination of a material having voids and a material which does not have voids. The negative electrode active material may be in the form of a sheet (foil or film) such as a lithium foil. Specifically, the negative electrode active material layer may be composed of a sheet of the negative electrode active material.

The electrolyte which may be contained in the negative electrode active material layer may be a solid electrolyte, a liquid electrolyte (electrolytic solution), or a combination of these. In particular, when the negative electrode active material layer contains at least a solid electrolyte as an electrolyte, and in particular, when the negative electrode active material layer does not contain any liquid other than the PFPE described above, a greater effect is likely to be obtained. When the first electrode 10 contains a sulfide solid electrolyte, the active material having voids described above, and the PFPE described above (for example, when the first active material layer 11 contains a sulfide solid electrolyte, the active material having voids described above, and the PFPE described above), an even greater effect is likely to be obtained.

The solid electrolyte may be any solid electrolyte which is known for secondary batteries. The solid electrolyte may be an inorganic solid electrolyte or an organic polymer electrolyte. In particular, inorganic solid electrolytes are excellent in ionic conductivity and heat resistance. Examples of inorganic solid electrolytes include oxide solid electrolytes such as lithium lanthanum zirconate, LiPON, Li_{1+X}Al_{X}Ge_{2-X}(PO₄)₃, Li—SiO-based glasses, and Li—Al—S—O— based glasses; and sulfide solid electrolytes such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS. In particular, the performance of the sulfide solid electrolyte, particularly the sulfide solid electrolyte containing at least Li, S and P as constituent elements, is high. The solid electrolyte may be amorphous or crystalline. The solid electrolyte may be, for example, in the form of particles. One type of solid electrolyte may be used alone, or two or more types thereof may be used in combination.

The electrolytic solution may contain predetermined carrier ions (for example, lithium ions). The electrolytic solution may be, for example, a non-aqueous electrolytic solution. The composition of the electrolytic solution may be the same as the known composition of the electrolytic solution of the secondary battery. For example, the electrolytic solution may be a carbonate-based solvent in which a lithium salt is dissolved at a predetermined concentration. Examples of carbonate-based solvents include fluoroethylene carbonate (FEC), ethylene carbonate (EC), and dimethyl carbonate (DMC). Examples of lithium salts include LiPF₆.

Examples of the conductive aid which may be contained in the negative electrode active material layer include carbon materials such as vapor-grown carbon fiber (VGCF), acetylene black (AB), Ketjen black (KB), carbon nanotubes (CNT), and carbon nanofibers (CNF); and metal materials such as nickel, aluminum, and stainless steel. The conductive aid may be, for example, particulate or fibrous, and the size thereof is not particularly limited. One type of conductive aid may be used alone, or two or more types thereof may be used in combination.

Examples of the binder that may be contained in the negative electrode active material layer include butadiene rubber (BR)-based binders, butylene rubber (IIR)-based binders, acrylate butadiene rubber (ABR)-based binders, styrene butadiene rubber (SBR)-based binders, polyvinylidene fluoride (PVdF)-based binders, polytetrafluoroethylene (PTFE)-based binders, and polyimide (PI)-based binders. One type of binder may be used alone, or two or more types thereof may be used in combination.

1.1.4 First Current Collector

As shown in FIG. 1, the first electrode 10 may comprise a first current collector 12 in contact with the first active material layer 11 described above. The first current collector 12 may be a negative electrode current collector or a positive electrode current collector. When the first current collector 12 is a negative electrode current collector, the second current collector 32 is a positive electrode current collector.

The negative electrode current collector may be any which is commonly used as the negative electrode current collector for a battery. The negative electrode current collector may be in the form of a foil, a plate, a mesh, a punched metal, or a foam. The negative electrode current collector may be a metal foil or a metal mesh, or may be a carbon sheet. In particular, metal foils are excellent in terms of ease of handling. The negative electrode current collector may be composed of a plurality of foils or sheets. Examples of metals constituting the negative electrode current collector include Cu, Ni, Cr, Au, Pt, Ag, Al, Fe, Ti, Zn, Co, and stainless steel. In particular, from the viewpoint of ensuring reduction resistance and preventing alloying with lithium, the negative electrode current collector may contain at least one metal selected from Cu, Ni, and stainless steel. The negative electrode current collector may have some type of coating layer on the surface thereof for the purpose of adjusting resistance. Furthermore, the negative electrode current collector may be a metal foil or a substrate on which the metal described above is plated or vapor-deposited. When the negative electrode current collector is composed of a plurality of metal foils, some sort of layer may be present between the plurality of metal foils. The thickness of the negative electrode current collector is not particularly limited. For example, it may be 0.1 μm or more or 1 μm or more, and may be 1 mm or less or 100 μm or less.

### 1.2 Electrolyte Layer

The electrolyte layer 20 is arranged between the first electrode 10 and the second electrode 30 and can function as a separator. The electrolyte layer 20 contains at least an electrolyte, and may further contain a binder or the like as desired. The electrolyte layer 20 may further contain other components such as a dispersant or the PFPE described above. The content of each component in the electrolyte layer 20 is not particularly limited, and may be appropriately determined in accordance with the desired battery performance. The shape of the electrolyte layer 20 is not particularly limited, and may be, for example, a sheet having a substantially flat surface. The thickness of the electrolyte layer 20 is not particularly limited, and may be, for example, 0.1 μm or more or 1 μm or more, and may be 2 mm or less or 1 mm or less.

### 1.2.1 Electrolyte

The electrolyte contained in the electrolyte layer 20 may be appropriately selected from those exemplified as electrolytes which may be contained in the negative electrode active material layer described above. In particular, an electrolyte layer 20 containing a solid electrolyte, and in particular, a sulfide solid electrolyte, and further a sulfide solid electrolyte containing at least Li, S, and P as constituent elements, has high performance. When the electrolyte is a solid electrolyte, the solid electrolyte may be amorphous or crystalline. When the electrolyte is a solid electrolyte, the solid electrolyte may be, for example, particulate. One type of electrolyte may be used alone, or two or more types thereof may be used in combination.

In the secondary battery 100, the sulfide solid electrolyte described above is contained in at least one of the first electrode 10 and the electrolyte layer 20. Specifically, the PFPE contained in the first electrode 10 can come into contact with at least one of the sulfide solid electrolyte contained in the first electrode 10 and the sulfide solid electrolyte contained in the electrolyte layer 20. Since PFPE has low reactivity with the sulfide solid electrolyte, even if the PFPE comes into contact with the sulfide solid electrolyte, change or deterioration of the sulfide solid electrolyte is unlikely to occur, and the high ionic conductivity of the sulfide solid electrolyte is likely to be maintained.

### 1.2.2 Binder

The binder which can be contained in the electrolyte layer 20 may be appropriately selected from, for example, those exemplified as binders which can be contained in the negative electrode active material layer described above.

### 1.3 Second Electrode

The second electrode 30 may be a positive electrode or a negative electrode. When the first electrode 10 is a negative electrode, the second electrode 30 is a positive electrode. The second electrode 30 may be any electrode that can appropriately function as a positive electrode or a negative electrode of a secondary battery, and the configuration thereof is not particularly limited.

### 1.3.1 Second Active Material Layer

As shown in FIG. 1, the second electrode 30 may comprise a second active material layer 31 and a second current collector 32. The second active material layer 31 may or may not contain the predetermined PFPE described above. When the second active material layer 31 contains a predetermined PFPE, the specific configuration thereof may be the same as that of the first active material layer 11. The second active material layer 31 may be a positive electrode active material layer or a negative electrode active material layer. When the first active material layer 11 is a negative electrode active material layer, the second active material layer 31 is a positive electrode active material layer.

The positive electrode active material layer contains at least a positive electrode active material. The positive electrode active material layer may also contain an electrolyte, a conductive aid, a binder, etc. The positive electrode active material layer may also contain various other additives such as the PFPE described above. The content of each component in the positive electrode active material layer may be appropriately determined in accordance with the desired battery performance. For example, when the total solid content of the positive electrode active material layer is 100 mass %, the content of the positive electrode active material may be 40 mass % or more, 50 mass % or more, 60 mass % or more, or 70 mass % or more, and may be 100 mass % or less, 95 mass % or less, or 90 mass % or less. Alternatively, when the total positive electrode active material layer is 100 vol %, the positive electrode active material, and optionally the electrolyte, the conductive aid, the binder, and the PFPE may be a total of 85 vol % or more, 90 vol % or more, or 95 vol % or more, and the remainder may be voids or other components. The shape of the positive electrode active material layer is not particularly limited, and may be, for example, a sheet-like positive electrode active material layer having a substantially flat surface. The thickness of the positive electrode active material layer is not particularly limited, and may be, for example, 0.1 μm or more, 1 μm or more, or 10 μm or more, and may be 2 mm or less, 1 mm or less, or 500 μm or less.

As the positive electrode active material, a material which is known as a positive electrode active material for secondary batteries may be used. Among known active materials, a material having a relatively noble potential (charge/discharge potential) for absorbing and releasing predetermined carrier ions (for example, lithium ions) can be used as the positive electrode active material, and a material having a relatively basic potential can be used as the negative electrode active material described above. The positive electrode active material may be at least one selected from, for example, various lithium-containing compounds, elemental sulfur, and sulfur compounds. The lithium-containing compound as the positive electrode active material may be any of various lithium-containing oxides such as lithium cobalt oxide, lithium nickel oxide, Li_{1±α}Ni_{1/3}Co_{1/3}Mn_{1/3}O_{2±δ}, lithium manganate, spinel-based lithium compounds (such as Li₁₊ₓMn_{2-x-y}M_{y}O₄ (where M is one or more selected from Al, Mg, Co, Fe, Ni, and Zn) substituted Li—Mn spinels), lithium titanate, and lithium metal phosphate (such as LiMPO₄, where M is one or more selected from Fe, Mn, Co, and Ni). In particular, when the positive electrode active material contains a lithium-containing oxide containing at least Li, at least one of Ni, Co, and Mn, and O as constituent elements, a greater effect can be expected. These positive electrode active materials may be used alone or in combination of two or more types thereof.

The shape of the positive electrode active material may be any shape which is common for the positive electrode active material of a battery. As described above, the positive electrode active material may be, for example, particulate. The positive electrode active material may have voids as described above, for example, may be porous or may be hollow. When the negative electrode active material contains an active material having voids, the positive electrode active material may have voids, may not have voids, or may be a combination of a material having voids and a material which does not have voids.

A protective layer containing an ion-conductive oxide may be formed on the surface of the positive electrode active material. As a result, the reaction between the positive electrode active material and a sulfide (for example, the sulfide solid electrolyte described above) can more easily be suppressed. Examples of ion-conductive oxides include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, and Li₂WO₄. The ion-conductive oxide may have some elements substituted with doping elements such as P and B. The coverage (area ratio) of the protective layer to the surface of the positive electrode active material may be, for example, 70% or more, 80% or more, or 90% or more. The thickness of the protective layer may be, for example, 0.1 nm or more or 1 nm or more, and may be 100 nm or less or 20 nm or less.

The electrolyte which may be contained in the positive electrode active material layer may be a solid electrolyte, a liquid electrolyte (electrolytic solution), or a combination of these. In particular, when the positive electrode active material layer contains at least a solid electrolyte as the electrolyte, a greater effect is likely to be obtained. The positive electrode active material layer may contain a solid electrolyte, in particular, a sulfide solid electrolyte, and further, a sulfide solid electrolyte containing Li, S, and P as constituent elements. Examples of the conductive aid which may be contained in the positive electrode active material layer include the carbon materials described above and the metal materials described above. The binder which may be contained in the positive electrode active material layer may be appropriately selected from, for example, those exemplified as binders which may be contained in the negative electrode active material layer described above.

### 1.3.2 Second Current Collector

As shown in FIG. 1, the second electrode 30 may contain a second current collector 32 which is in contact with the second active material layer 31. The second current collector 32 may be a positive current collector or a negative current collector. When the first current collector 12 is a negative current collector, the second current collector 32 is a positive current collector.

The positive electrode current collector may be any which is commonly used as the positive electrode current collector of a battery. The positive electrode current collector may be in the form of a foil, a plate, a mesh, a punched metal, or a foam. The positive electrode current collector may be composed of a metal foil or a metal mesh. In particular, metal foils are excellent in terms of ease of handling. The positive electrode current collector may be composed of a plurality of foils. Examples of metals for constituting the positive electrode current collector include Cu, Ni, Cr, Au, Pt, Ag, Al, Fe, Ti, Zn, Co, and stainless steel. In particular, the positive electrode current collector may contain Al from the viewpoint of ensuring oxidation resistance. The positive electrode current collector may have some type of coating layer on the surface thereof for the purpose of adjusting resistance. The positive electrode current collector may be a metal foil or a substrate on which the metal described above is plated or vapor-deposited. When the positive electrode current collector is composed of a plurality of metal foils, some layers may be present between the plurality of metal foils. The thickness of the positive electrode current collector is not particularly limited. For example, it may be 0.1 μm or more or 1 μm or more, and 1 mm or less or 100 μm or less.

### 1.4 Other Configurations

In the secondary battery 100, each of the components described above may be housed inside an exterior body. Any known exterior body for a battery can be used as the exterior body. Furthermore, a plurality of secondary batteries 100 may be electrically connected in any manner and stacked in any manner to form a battery pack. In this case, the battery pack may be housed inside a known battery case. The secondary battery 100 may also comprise other obvious components such as necessary terminals. Examples of the shape of the secondary battery 100 include a coin type, a laminate type, a cylindrical type, and a rectangular type.

### 2. Secondary Battery Production Method

The secondary battery 100 can be produced by adopting a known method. For example, it can be produced as follows. However, the production method for the secondary battery 100 is not limited to the following method, and each layer may be formed by, for example, dry molding or the like.
(1) The negative electrode active material constituting the negative electrode active material layer is dispersed in a solvent to obtain a negative electrode slurry. The solvent used in this case is not particularly limited, and may be water or any of various organic solvents, or may be N-methylpyrrolidone (NMP). Thereafter, the negative electrode slurry is applied to the surface of a negative electrode current collector or an electrolyte layer as described below using a doctor blade or the like, and then dried to form a negative electrode active material layer on the surface of the negative electrode current collector or the electrolyte layer, thereby forming a negative electrode. The negative electrode active material layer may be press-molded.
(2) The positive electrode active material constituting the positive electrode active material layer is dispersed in a solvent to obtain a positive electrode slurry. The solvent used in this case is not particularly limited, and water or any of various organic solvents can be used, and N-methylpyrrolidone (NMP) may also be used. Thereafter, the positive electrode slurry is applied to the surface of a positive electrode current collector or an electrolyte layer as described below using a doctor blade or the like, and then dried to form a positive electrode active material layer on the surface of the positive electrode current collector or the electrolyte layer, thereby forming a positive electrode. The positive electrode active material layer may be press molded.
(3) Each layer is laminated so that the electrolyte layer is interposed between the negative electrode and the positive electrode to obtain a laminate having a negative electrode current collector, a negative electrode active material layer, an electrolyte layer, a positive electrode active material layer, and a positive electrode current collector in this order. The electrolyte layer may be obtained by molding an electrolyte mixture containing, for example, an electrolyte and a binder, or may be obtained by press-molding. The laminate may be further press molded. Other members such as terminals are attached to the laminate as needed.
(4) The laminate is placed in a battery case and sealed to obtain a secondary battery.

By incorporating the PFPE described above into the active material layer in at least one of steps (1) and (2) above, the filling rate of the active material layer can be increased even when the active material layer is press-molded at low pressure, and as a result, a secondary battery having low resistance can be easily obtained. Furthermore, by press-molding the active material layer at a low pressure, crushing of the active material having voids can easily be suppressed, and as a result, a secondary battery having excellent cycle characteristics can be easily obtained. By including a sulfide solid electrolyte in at least one of the active material layer and the electrolyte layer in steps (1) to (3), even if the PFPE comes into contact with the sulfide solid electrolyte, a reaction between the PFPE and the sulfide solid electrolyte is unlikely to occur, whereby the high ionic conductivity of the sulfide solid electrolyte can easily be maintained.

The technology of the present disclosure also includes an aspect of a method for the production of a secondary battery as described below. Specifically, in an embodiment, the method for the production of the secondary battery 100 comprises the following steps:
molding a first electrode mixture to obtain a first electrode 10,
molding an electrolyte mixture to obtain an electrolyte layer 20, and
molding a second electrode mixture to obtain a second electrode 30, wherein
at least one of the first electrode mixture and the electrolyte mixture contains a sulfide solid electrolyte,
the first electrode mixture contains an active material having voids and a perfluoropolyether represented by formula (1) above, and
during molding of the first electrode mixture, a pressure exceeding 0 kN/cm and 15 kN/cm or less is exerted on the first electrode mixture.

The first electrode mixture or the second electrode mixture may contain the materials constituting the negative electrode active material layer or positive electrode active material layer described above, and the electrolyte mixture may contain the materials constituting the electrolyte layer described above. In the production method of the present disclosure, the pressure during molding of the first electrode mixture is a low pressure of 15 kN/cm or less, whereby crushing of the active material having voids contained in the first electrode mixture is suppressed. Furthermore, since the first electrode mixture contains the predetermined PFPE, the filling rate of the mixture in the first electrode 10 is likely to be high even when the first electrode mixture is pressed at a low pressure. The lower limit of the pressure during pressing is not particularly limited, and may be greater than 0 kN/cm, 1 kN/cm or more, 2 kN/cm or more, 3 kN/cm or more, 4 kN/cm or more, 5 kN/cm or more, 6 kN/cm or more, 7 kN/cm or more, 8 kN/cm or more, 9 kN/cm or more, or 10 kN/cm or more. The means and method for applying pressure to the first electrode mixture are also not particularly limited, and various pressurizing means and pressurizing methods such as roller pressing and CIP can be adopted.

In the above descriptions, the unit of pressure applied to the first electrode mixture is described as “kN/cm”, but this is merely exemplary. Specifically, the pressure applied to the first electrode mixture is not limited to linear pressure, and may be surface pressure. Even when the pressure applied to the first electrode mixture is surface pressure, the surface pressure can be converted to linear pressure. The specific conversion method is not particularly limited, and the surface pressure may be converted to linear pressure by experimentally and statistically identifying the relationship between the surface pressure and the linear pressure via various experimentation, or the surface pressure may be theoretically converted to linear pressure via calculation. As far as has been confirmed by the present inventors, for example, when the surface pressure is approximately 37.5 kN/cm, the linear pressure is approximately 75 kN/cm, and when the surface pressure is approximately 7.5 kN/cm, the linear pressure is approximately 15 kN/cm.

### 3. Supplementary Information

The technology of the present disclosure can be applied not only to lithium-ion secondary batteries, but also to secondary batteries other than lithium-ion secondary batteries (for example, sodium-ion secondary batteries). However, when the technology of the present disclosure is applied to lithium-ion secondary batteries, it is likely to exhibit even greater effects.

### EXAMPLES

The technology of the present disclosure will be described in more detail below with reference to Examples, but the technology of the present disclosure is not limited to the following Examples.

### 1. Preparation of Positive Electrode for Pressing

A binder (PVdF), a conductive aid (VGCF), a sulfide solid electrolyte (LiI—LiBr—Li₂S—P₂S₅), and a positive electrode active material (LiNi_{0.80}Co_{0.15}Mn_{0.05}O₂) were added to an organic solvent, and were kneaded using an ultrasonic homogenizer to obtain a positive electrode mixture slurry. The obtained positive electrode mixture slurry was applied onto an Al foil and dried to obtain a positive electrode for pressing.

### 2. Preparation of Negative Electrode for Pressing

A binder (PVdF), a conductive aid (VGCF), a sulfide solid electrolyte (LiI—LiBr—Li₂S—P₂S₅), a negative electrode active material (Si), and optionally a perfluoropolyether (PFPE) were added to an organic solvent, and were kneaded using an ultrasonic homogenizer to obtain a negative electrode mixture slurry. The obtained negative electrode mixture slurry was applied onto a Cu foil and dried to obtain a negative electrode for pressing. By changing the amount of PFPE added, a plurality of negative electrodes for pressing having different volume fractions of PFPE in the mixture were obtained. The volume fraction of PFPE in each negative electrode for pressing is as shown in Table 1 below. The PFPE was a liquid having a chemical structure represented by the following formula (I) (where m/n is 1.2, the number average molecular weight is 5120, and the terminal R has CF₃ and CF₂CF₃ in an average ratio of 1:0.17).

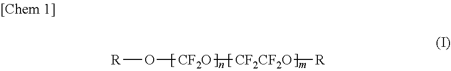

### 3. Preparation of Electrolyte Layer for Pressing

A binder (PVdF) and a sulfide solid electrolyte (LiI—LiBr—Li₂S—P₂S₅) were added to an organic solvent and kneaded using an ultrasonic homogenizer to obtain an electrolyte mixture slurry. The obtained electrolyte mixture slurry was applied onto an Al foil and dried to obtain an electrolyte layer for pressing.

### 4. Battery Construction

The positive electrode, negative electrode, and electrolyte layer for pressing were each formed into a rectangular shape, and the mixture surface of the positive electrode for pressing and the mixture surface of the electrolyte layer for pressing were stacked, and then roller-pressed at 165° C. at a pressure of 50 kN/com, and the Al foil of the electrolyte layer for pressing was peeled off to obtain a laminate (A) of Al foil, positive electrode active material layer, and electrolyte layer. The mixture surface of the negative electrode for pressing and the mixture surface of the electrolyte layer for pressing were stacked, and then roller-pressed at 25° C. at the pressure shown in Table 1 below, and the Al foil of the electrolyte layer for pressing was peeled off to obtain a laminate (B) of Cu foil, negative electrode active material layer, and electrolyte layer. The laminate (A) was punched to φ11.28 mm, and the laminate (B) was punched to φ 13.00 mm. An electrolyte layer was further transferred to the laminate (B) using a uniaxial press, and the laminate (A) and the laminate (B) were then stacked to obtain an electrode body having a structure of Al foil/positive electrode active material layer/electrolyte layer/negative electrode active material layer/Cu foil. Current extraction tabs were attached to the Al foil and Cu foil of the electrode body, and the electrode body was sealed in a laminate pack using a vacuum-lami sealer to prepare a battery for evaluation.

### 5. Evaluation of Battery Resistance

The resistance of the battery for evaluation prepared as described above was measured. Specifically, the resistance value of the real axis intercept on the low frequency side of the circular component was read from the Nyquist plot obtained by the AC impedance method, and this was determined as the resistance of the battery.

### 6. Evaluation of Cycle Characteristics of Battery

The evaluation battery prepared as described above was subjected to a charge/discharge test 100 times, in which the battery was charged at a constant current of 1 mA up to 4.05 V and then discharged at a constant current of 1 mA to 1.5 V. The battery resistance before the charge/discharge test (initial resistance) and the battery resistance after the charge/discharge test were measured in the same manner as described above, and the increase rate of the battery resistance after the charge/discharge test was calculated from the ratio of the battery resistance after the charge/discharge test to the battery resistance before the charge/discharge test.

### 7. Evaluation Results

The evaluation results are shown in Table 1 below. The configurations and preparation conditions of the positive electrode and the electrolyte layer are the same between the Examples and Comparative Examples, and thus, have been omitted from Table 1. The evaluation results of battery resistance (initial resistance) before the charge/discharge test are shown relative to the resistance value of Comparative Example 1, which is set as a baseline (100.0).

TABLE 1

| | | | | | | | | Battery resistance | | |
|---|---|---|---|---|---|---|---|---|---|---|
| | | | | | PFPE | | | (initial resistance) | | |
| | | | | | | Volume | | | Resistance | Cycle characteristics |
| | Negative electrode | Solid | Conductive | | | ratio | Pressing pressure | | reduction | resistance increase rate |
| | active material | electrolyte | aid | Binder | Type | (vol %) | kN/cm | — | effect | (%) |
| Comp Ex 1 | Porous Si | Sulfide | VGCF | PVdF | N/A | — | 50 | 100.0 | — | 250 |
| Comp Ex 2 | Porous Si | Sulfide | VGCF | PVdF | N/A | — | 30 | 115.1 | — | 215 |
| Comp Ex 3 | Porous Si | Sulfide | VGCF | PVdF | N/A | — | 15 | 135.2 | — | 188 |
| Comp Ex 4 | Porous Si | Sulfide | VGCF | PVdF | N/A | — | 10 | 201.0 | — | 173 |
| Comp Ex 5 | Porous Si | Sulfide | VGCF | PVdF | N/A | — | 5 | 266.2 | — | 119 |
| Ex 1 | Porous Si | Sulfide | VGCF | PVdF | PFPE | 8 | 15 | 101.1 | −34 | 180 |
| Ex 2 | Porous Si | Sulfide | VGCF | PVdF | PFPE | 8 | 10 | 103.3 | −98 | 170 |
| Ex 3 | Porous Si | Sulfide | VGCF | PVdF | PFPE | 8 | 5 | 135.8 | −130 | 115 |
| Ex 4 | Porous Si | Sulfide | VGCF | PVdF | PFPE | 25 | 10 | 130.2 | −71 | 168 |
| Ex 5 | Porous Si | Sulfide | VGCF | PVdF | PFPE | 12 | 10 | 105.3 | −96 | 172 |
| Ex 6 | Porous Si | Sulfide | VGCF | PVdF | PFPE | 3 | 10 | 125.9 | −75 | 175 |
| Ex 7 | Porous Si | Sulfide | VGCF | PVdF | PFPE | 1 | 10 | 139.0 | −62 | 171 |

The results shown in Table 1 indicate the following:
(1) As shown in Comparative Examples 1 to 5, the lower the pressure during molding of the negative electrode, the higher the battery resistance. It is considered that when the molding pressure was reduced, the filling rate of the mixture decreased, resulting in an active material layer having many gaps, which increased the battery resistance. The lower the pressure during molding of the negative electrode, the better the cycle characteristics of the battery. This is considered to be because the low pressure during molding made it unlikely for the active material (porous Si) with voids to be crushed, and as a result, the voids in the active material were maintained, which suppressed expansion of the volume of the active material during charging.
(2) As shown in Comparative Examples 3 to 5 and Examples 1 to 3, when the pressure during molding of the negative electrode was the same, the battery resistance was smaller when the mixture contained PFPE (Examples 1 to 3) than when the mixture did not contain PFPE (Comparative Examples 3 to 5). In Examples 1 to 3, it is considered that the lubricating effect of PFPE increased the fluidity of the mixture during molding of the negative electrode, whereby an active material layer having a high filling rate was obtained, resulting in a reduced battery resistance.
(3) As shown in Examples 4 to 7, the resistance of the battery was reduced and the cycle characteristics of the battery were improved regardless of the amount (volume ratio) of PFPE added in the mixture.

Though a PFPE having a specific chemical structure is exemplified in the Examples described above, the chemical structure of the PFPE is not limited thereto. Furthermore, though the case in which an active material having voids was used as the negative electrode active material, and the PFPE was contained in the negative electrode side is exemplified in the Examples described above, the same effects can be expected even when an active material having voids is used as the positive electrode active material, and the PFPE is contained in the positive electrode side. Furthermore, the mixture composition of the positive electrode, electrolyte layer, and negative electrode is not limited to the foregoing.

As described above, in a secondary battery having the following features, it is easy to achieve both excellent cycle characteristics and a low resistance:
(1) comprising a first electrode, an electrolyte layer, and a second electrode;
(2) at least one of the first electrode and the electrolyte layer contains a sulfide solid electrolyte; and
(3) the first electrode contains an active material having voids and a specific perfluoropolyether.

### Description Of Reference Signs

10 first electrode
11 first active material layer
12 first current collector
20 electrolyte layer
30 second electrode
31 second active material layer
32 second current collector
100 secondary battery

1. A secondary battery, comprising a first electrode, an electrolyte layer, and a second electrode, wherein
at least one of the first electrode and the electrolyte layer contains a sulfide solid electrolyte and
the first electrode contains an active material having voids, and a perfluoropolyether represented by formula (1) below: 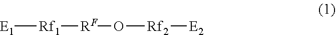
where Rf₁ and Rf₂ are each independently a C₁₋₁₆ divalent alkylene group which may be substituted with one or more fluorine atoms,
E₁ and E₂ are each independently a monovalent group selected from the group consisting of a fluorine group, a hydrogen group, a hydroxyl group, an aldehyde group, a carboxylic acid group, a C₁₋₁₀ alkyl ester group, an amide group which may have one or more substituents, and an amino group which may have one or more substituents, and
R^{F} is a divalent fluoropolyether group.

2. The secondary battery according to claim 1, wherein
R^{F} is a group represented by formula (2): 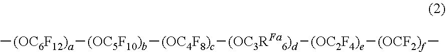
where each R^{Fa} is independently a hydrogen atom, a fluorine atom, or a chlorine atom,
a, b, c, d, e, and f are each independently an integer of 0 to 200,
the sum of a, b, c, d, e, and f is 1 or more,
the order of occurrence of each repeating unit enclosed in parentheses with the subscript a, b, c, d, e, or f is arbitrary in the formula, and
under the proviso that when all Ra are hydrogen atoms or chlorine atoms, at least one of a, b, c, e, and f is 1 or more.

3. The secondary battery according to claim 2, wherein
each R^{Fa} is a fluorine atom.

4. The secondary battery according to claim 3, wherein
each R^{F} is independently a group represented by formula (2-1), (2-2), (2-3), (2-4), or (2-5) below: 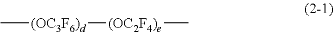
where d is an integer from 1 to 200, and e is 0 or 1; 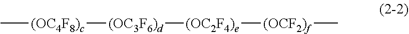
where c and d are each independently an integer of 0 to 30,
e and f are each independently an integer of 1 to 200,
the sum of c, d, e, and f is an integer of 10 to 200, and
the order of occurrence of each repeating unit enclosed in parentheses with the subscript c, d, e or f is arbitrary in the formula; 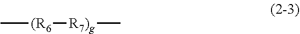
where R₆ is OCF₂ or OC₂F₄,
R₇ is a group selected from OC₂F₄, OC₃F₆, OC₄F₈, OC₅F₁₀, and OC₆F₁₂, or a combination of two or three groups selected from these groups, and
g is an integer of 2 to 100; 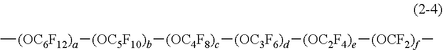
where e is an integer of 1 or more and 200 or less,
a, b, c, d, and f are each independently an integer of 0 or more and 200 or less, and
the order of occurrence of each repeating unit enclosed in parentheses with the subscript a, b, c, d, e, or f is arbitrary in the formula; and 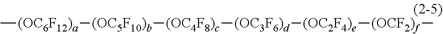
where f is an integer of 1 or more and 200 or less,
a, b, c, d, and e are each independently an integer of 0 or more and 200 or less, and
the order of occurrence of each repeating unit enclosed in parentheses with the subscript a, b, c, d, e, or f is arbitrary in the formula.

5. The secondary battery according to claim 4, wherein
each R^{F} is a group represented by formula (2-6) below: 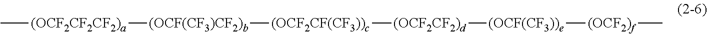
where a, b, c, d, e, and f are each independently an integer of 0 to 200,
the sum of a, b, c, d, e, and f is 1 or more, and
the order of occurrence of each repeating unit enclosed in parentheses with the subscript a, b, c, d, e, or f is arbitrary in the formula.

6. The secondary battery according to claim 4, wherein
each R^{F} is a group represented by formula (2-7) below: 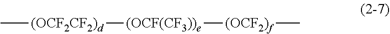
where d, e, and f are each independently an integer of 0 to 200,
the sum of d, e, and f is 1 or more, and
the order of occurrence of each repeating unit enclosed in parentheses with the subscript d, e, or f is arbitrary in the formula.

7. The secondary battery according to claim 1, wherein
E₁-Rf₁ and E₂-Rf₂ are each independently a group selected from the group consisting of —CF₃, —CF₂CF₃, and —CF₂CF₂CF₃.

8. The secondary battery according to claim 1, wherein
the first electrode comprises a first active material layer, and
the first active material layer contains 1 vol % or more and 25 vol % or less of the perfluoropolyether.

9. The secondary battery according to claim 1, wherein
the first electrode is a negative electrode, and
the active material having the voids contains Si or a Si alloy.

10. The secondary battery according to claim 1, wherein
the first electrode contains the sulfide solid electrolyte, the active material having the voids, and the perfluoropolyether.

11. A method for the production of a secondary battery, the method comprising:
molding a first electrode mixture to obtain a first electrode,
molding an electrolyte mixture to obtain an electrolyte layer, and
molding a second electrode mixture to obtain a second electrode, wherein
at least one of the first electrode mixture and the electrolyte mixture contains a sulfide solid electrolyte,
the first electrode mixture contains an active material having voids, and a perfluoropolyether represented by formula (1) below, and
during molding of the first electrode mixture, a pressure exceeding 0 kN/cm and 15 kN/cm or less is exerted on the first electrode mixture: 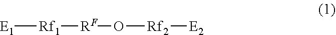
where Rf₁ and Rf₂ are each independently a C₁₋₁₆ divalent alkylene group which may be substituted with one or more fluorine atoms,
E₁ and E₂ are each independently a monovalent group selected from the group consisting of a fluorine group, a hydrogen group, a hydroxyl group, an aldehyde group, a carboxylic acid group, a C₁₋₁₀ alkyl ester group, an amide group which may have one or more substituents, and an amino group which may have one or more substituents, and
R^{F} is a divalent fluoropolyether group.
